(19) United States
(12) Patent Application Publication
(10) Pub. No.: US 2024/0253581 A1
(43) Pub. Date: Aug. 1, 2024

(54) ARRANGEMENT OF A MOTOR VEHICLE SENSOR DEVICE

(71) Applicant: Dr. Ing. h.c. F. Porsche Aktiengesellschaft, Stuttgart (DE)

(72) Inventors: Thomas Weiss, Calw-Heumaden (DE); Stephan Puchmueller, Friolzheim (DE)

(21) Appl. No.: 18/426,450

(22) Filed: Jan. 30, 2024

(30) Foreign Application Priority Data
Feb. 1, 2023 (DE) 10 2023 102 399.3

(51) Int. Cl. B60R 13/08; G01S 7/521; G01S 15/931

(52) U.S. Cl. CPC B60R 13/0869; G01S 7/521; G01S 2015/938

(57) ABSTRACT

An arrangement (1) is provided for holding of a motor vehicle sensor device (2) in a thermally exposed area near an exhaust system (5) of a motor vehicle. The motor vehicle sensor device (2) includes a sensor (10) and a holding device (3) having a receptacle (7), within which the sensor means is accommodated. The holding device (3) is fixed to an inner side (40) of an external paneling component (4) in the thermally exposed area. The motor vehicle sensor device (2) includes a cover (8), by means of which the receptacle (7) is covered on an interior side of the vehicle. The cover (8) is made of a thermally insulating material or has a thermally insulating coating.

### CROSS-REFERENCE TO RELATED APPLICATION

This application claims priority on German Patent Application No 10 2023 102 399.3 filed Feb. 1, 2023, the entire disclosure of which is incorporated herein by reference.

### BACKGROUND

Field of the Invention. The invention relates to an arrangement of a motor vehicle sensor device in a thermally exposed area near an exhaust system of a motor vehicle.

Related Art. The prior art includes motor vehicle sensor devices that have an ultrasonic sensor arranged in a through-opening of an external paneling component of the motor vehicle. The external paneling component can be a front bumper or a rear bumper of the motor vehicle. Such motor vehicle sensor devices are used for parking aids or other driving assistance systems. These sensor devices can be exposed to very high temperatures during operation, such as when the sensor device is in a thermally exposed area near an exhaust system of the motor vehicle. Thus, there is a possibility that the maximum allowable limit temperature for the operation of the sensor is exceeded, and a sensor malfunction or defect can occur.

US 2021/031701 A1 discloses a motor vehicle sensor device with a sensor attached to a body side portion so that an air gap is provided between the sensor and the sensor attachment. The air gap is intended to function as a heat barrier and shields the sensor against a hot exhaust system of a motor vehicle.

An object of the invention is to provide a simple and cost-efficient arrangement of a motor vehicle sensor device in a thermally exposed area of a motor vehicle that avoids exceeding the maximum permitted limit temperature for operation of the sensor.

### SUMMARY OF THE INVENTION

An arrangement of a motor vehicle sensor device in accordance with this disclosure is configured to be disposed in a thermally exposed area near an exhaust system of a motor vehicle. The motor vehicle sensor device comprises a sensor and a holding device. The holding device has a receptacle within which the sensor is accommodated. The holding device of some embodiments can be fixed to an inner side of an external paneling component that is arranged in the thermally exposed area. The motor vehicle sensor device of some embodiments comprises a cover that covers the receptacle on an interior side of the vehicle. The cover is made of a thermally insulating material or comprises a thermally insulating coating.

The cover has thermally insulating properties that prevent the cover from exceeding a maximum allowable limit temperature of the sensor of the motor vehicle sensor device. Thus, the cover prevents a malfunction or defect of the sensor in a simple and inexpensive manner.

The cover of one embodiment is made of a thermally insulating, heat-resistant plastic. The particular plastic used for the cover depends on the temperatures at the installation location of the motor vehicle sensor device, and the thermally insulating plastic is selected to be sufficiently heat-resistant to prevent exceeding the limit temperature for the operation of the sensor of the motor vehicle sensor device. A thermally insulating plastic of some embodiments is heat-resistant to at least 200° C., preferably to at least 400° C., and in particular to at least 600° C.

In an alternate embodiment, the cover is made of a thermally insulating ceramic material.

In a further alternate, the cover has a thermally insulating ceramic coating.

Further features and advantages of the invention will become apparent from the following description of a preferred embodiment with reference to the drawing.

### BRIEF DESCRIPTION OF THE DRAWING

FIG. 1 is a perspective view of an arrangement of a motor vehicle sensor device in a thermally exposed area near an exhaust system of a motor vehicle.

FIG. 2 is a schematic cross-section of the sensor device.

### DETAILED DESCRIPTION

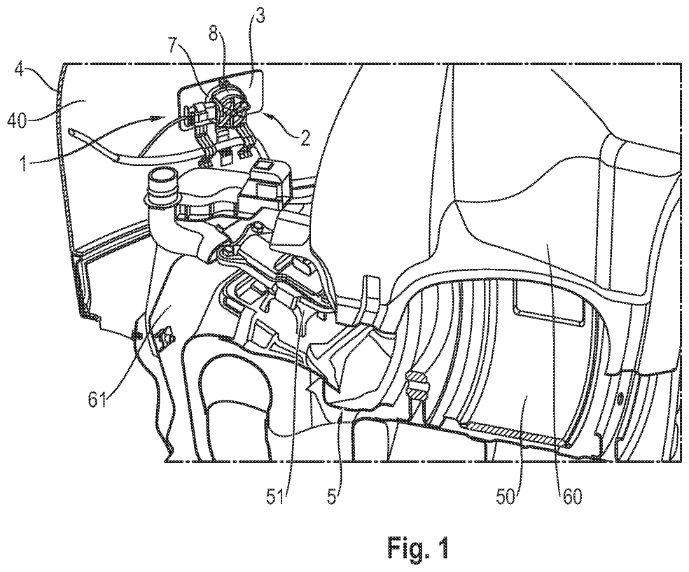

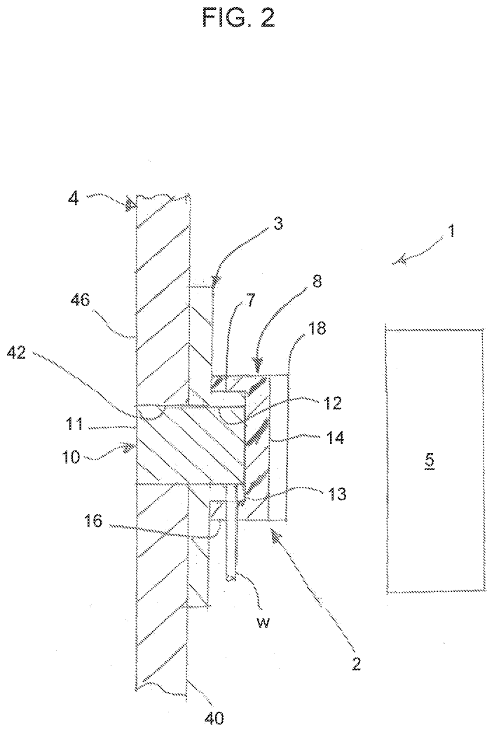

FIGS. 1 and 2 illustrate an arrangement 1 of a motor vehicle sensor device 2 in a thermally exposed area near an exhaust system 5 of a motor vehicle. In the present case, the motor vehicle sensor device 2 is a portion of a driver assistance system of the motor vehicle, in particular a parking aid, and comprises a sensor 10, such as a proximity sensor. The sensor 10 can be an ultrasonic sensor that is configured to emit and/or receive ultrasonic waves for identifying proximity to another object, such as another vehicle. A wire W extends from the sensor 10 to a control device on the vehicle. The sensor 10 is operative to detect obstacles in a close range of the motor vehicle and alerts a driver of the motor vehicle of impending collisions.

The motor vehicle sensor device 2 is attached to an inner side 40 of an external paneling component 4 of the motor vehicle. The external paneling component 4 of this embodiment can be a rear bumper or a rear fender located near the exhaust system 5 and thus in a thermally exposed area of the motor vehicle.

The exhaust system 5 shown in FIG. 1 comprises a main silencer 50, a flap adjuster 51 for an exhaust flap of the exhaust system 5, as well as exhaust cleaning components, such as catalytic converters and particulate filters. These components reach high temperatures during operation of a combustion engine upstream of the exhaust system 5. Thus, the main silencer 50, the flap adjuster 51, and exhaust gas cleaning components are each wrapped, at least in sections, with a metallic heat shield 60, 61.

The motor vehicle sensor device 2 comprises a sensor holding device 3 for holding the sensor 10, and the sensor holding device 3 is attached to an inner side 40 of the external paneling component 4. The sensor holding device 3 comprises a receptacle 7 that forms a receiving space 12 within which the sensor 10 is accommodated. The receptacle 7 comprises a wall 13 that laterally encloses the sensor 10 accommodated within the receiving space 12 in an annular manner.

The motor vehicle sensor device 2 further comprises a cover 8 that is configured to close the receiving space of the receptacle 7 on the inside of the vehicle. The cover 8 comprises a cover bottom 14 and an annular side wall 16. The cover 8 is shaped so that the side wall 16 of the cover 8 encompasses the wall 13 of the receptacle 7 of the sensor holding device 3 surrounded by the receiving space 12 after assembly. The receptacle 7 of the sensor holding device 3 as well as the cover 8 are configured so that the cover 8 can be locked to the sensor holding device 3 during assembly. Other types of attachment are generally conceivable. To increase bending stiffness, the cover 8 in the embodiment shown in FIG. 2 is provided with several reinforcing ribs 18.

The external paneling component 4 has a through-opening 42, as shown schematically in FIG. 2. The sensor 10 of the motor vehicle sensor device 2 extends into the through-opening 42 after assembly to such an extent that an outer sensor surface 11 is flush with an outer side 46 of the external paneling portion 4.

As mentioned above, very high temperatures occur in the area of the exhaust system 5 during operation of the combustion engine. The cover 8 is configured to have thermally insulating properties to prevent a maximum allowable limit temperature for the operation of the sensor 10 of the motor vehicle sensor device 1 from being exceeded, thereby preventing a temperature-related malfunction or defect of the sensor 10.

For this purpose, the cover 8 can be made entirely from a thermally insulating material or can comprise a thermally insulating coating. For example, the cover 8 is made of a thermally insulating, heat-resistant plastic. Depending on the temperatures at the installation location of the motor vehicle sensor device 1, a thermally insulating plastic is selected that is sufficiently heat-resistant and prevents exceeding the limit temperature for the operation of the sensor 10 of the motor vehicle sensor device 1. For example, the cover 8 is made of a thermally insulating plastic that is heat-resistant to at least 200° C., preferably to at least 400° C., and in particular to at least 600° C. Alternatively, the cover 8 can be made of a ceramic material or can comprise a coating of a ceramic material.

1. An arrangement (1) of a motor vehicle sensor device (2) in a thermally exposed area near an exhaust system (5) of a motor vehicle, the motor vehicle sensor device (2) comprising a sensor (10) and a holding device (3) having a receptacle (7) within which the sensor (10) is accommodated, the holding device (3) being fixed to an inner side (40) of an outer cover component (4) that is arranged in the thermally exposed area, the motor vehicle sensor device (2) having a cover (8) that covers the receptacle (7) on an interior side of the vehicle, and the cover (8) being made of a thermally insulating material or comprises a thermally insulating coating.

2. The arrangement (1) of claim 1, wherein the cover (8) is made of a thermally insulating, heat-resistant plastic.

3. The arrangement of claim 2, wherein the plastic is heat-resistant to at least 200° C.

4. The arrangement (1) of claim 1, wherein the cover (8) is made of a thermally insulating ceramic material.

5. The arrangement (1) of claim 1, wherein the thermally insulating material of the cover (8) is a ceramic coating.
